(19) United States
(12) Patent Application Publication
(10) Pub. No.: US 2026/0192485 A1
(43) Pub. Date: Jul. 9, 2026

(54) Process To Make Silicate Functionalized Engineered Wood Articles With Improved Properties

(71) Applicant: T2EARTH HOLDINGS LLC, Jericho, NY (US)

(72) Inventors: Edward John FEWKES, Modoc, SC (US); Andrew Kegan LYON, Evans, GA (US); Jeffrey F. TAYLOR, Evan, GA (US)

(73) Assignee: T2EARTH HOLDINGS LLC, Jericho, NY (US)

(21) Appl. No.: 19/133,025

(22) PCT Filed: Nov. 28, 2023
(86) PCT No.: PCT/US2023/081270

§ 371 Date: May 27, 2025

Related U.S. Application Data
(60) Provisional application No. 63/428,257, filed on Nov. 28, 2022.

(51) Int. Cl. B27K 3/18; B27K 3/08; B27K 5/04; B32B 7/12; B32B 21/02; B32B 21/04; B32B 21/14; B32B 37/12

(52) U.S. Cl. CPC B27K 3/18; B27K 3/08; B32B 7/12; B32B 21/02; B32B 21/042; B32B 21/14; B32B 37/12; B27K 5/04; B27K 2240/30; B32B 2037/1253; B32B 2260/026; B32B 2260/04; B32B 2307/3065

(57) ABSTRACT

This disclosure relates to a process for manufacturing a flame-retardant, glued engineered wood article. The process comprises providing an engineered wood component treated by impregnation with a metal silicate solution, exposing the metal-silicate treated engineered wood component to an adhesive, and bonding multiple units of the metal-silicate treated engineered wood via the adhesive to form a flame-retardant, glued engineered wood article. This disclosure also relates to a flame-retardant, glued engineered wood article prepared by the processes described herein.

### PRIORITY CLAIM

This is a U.S. national stage of application No. PCT/US2023/081270 filed on Nov. 28, 2023. This application claims priority to U.S. Provisional Application No. 63,428,257, filed on Nov. 28, 2022, which is herein incorporated by reference in its entirety.

### FIELD OF THE INVENTION

This invention generally relates to the field of a flame-retardant, glued engineered wood article.

### BACKGROUND OF THE INVENTION

Wood is a building material that has been in use for millennia. Joining multiple pieces of wood together as well as joining wood to other materials are important. This joining may be accomplished mechanically using nails, screws, or fastening plates. Recently, wood glues or adhesives have seen more common usage. For instance, wood glues can be applied to wood, followed by securing the joint until the glue-wood adhesion has been developed and glue has been allowed to fully cure.

A typical approach to improve the adhesion, durability, or cure rate of a glue or adhesive has been formulating or re-formulating the glues or adhesives themselves by changing components and other additives of the glues or adhesives. For instance, additives may be added to a glue that can roughen the surface of wood or treat the surface of wood to improve mechanical interlock between wood. Another way is to create chemical bond or a more chemically compatible interface between the wood substrate(s) and adhesive. For instance, using a catalyst at the surface, in the case of moisture cure or epoxy adhesives, may develop adhesion or increase the reaction rate.

Sodium silicate has been used to catalyze a faster curing reaction for some glues commonly used in wood adhesion. For example, Liu et al., “PVA Wood Adhesive Modified with Sodium Silicate Cross-Linked Copolymer” published by IEEE in Proceedings of 2012 International Conference on Biobase Material Science and Engineering (BMSE) (2012) and Liu et al., “Study on the effect of organic additives and inorganic fillers on properties of sodium silicate wood adhesive modified by polyvinyl alcohol,” BioResources, 10(1): 1528-42 (2015) describe the effect of adding sodium silicate to polyvinyl acetate to form a wood glue on the cure time of the glue, as well as the bond strength and water resistance of the glue. However, the reference does not address treating wood with sodium silicate impregnation or the effect of the sodium silicate impregnation on the flame retardant characteristics of the treated wood.

U.S. Pat. No. 8,323,449 discloses the addition of sodium silicate into polyphenolic adhesive, a popular class of glue for composites such as plywood, as part of an extender formulation intended to reduce the amount of adhesive necessary. The patent also discloses that the re-formulation of the adhesive requires including poly-hydridic alcohols to improve the shelf life and increase working time of the glue, because the simple addition of sodium silicate to the phenol formaldehyde or melamine urea adhesives can cause rapid gelation. However, the patent does not address treating wood with sodium silicate impregnation, the interaction of the sodium silicate with treated wood, or the effect of silicate impregnation on the flame retardant characteristics of the treated wood.

Silicate adhesives have also been used alone as inorganic adhesive. For instance, U.S. Pat. No. 3,663,355 discloses the use of sodium silicate as an inorganic adhesive layer in bonding wooden plates. However, this patent does not address treating wood with sodium silicate impregnation or the interaction of the sodium silicate or adhesive with silicate-treated wood; nor does the patent discuss any flame retardant characteristics of wood.

All the aforementioned references and patents relate to either the direct addition of sodium silicate to an adhesive or using sodium silicate by itself as an adhesive layer. None of them disclose treating engineered wood component with metal silicate impregnation, and then bonding the silicate-treated engineered wood component with an adhesive, and the benefits associated with such process, much less the unique benefit brought by such process to improve the mechanical properties as well as the flame retardant characteristics of the glued, silicate-treated engineered wood.

Sodium silicates have been used to impregnate wood products. U.S. Pat. Nos. 6,827,984 and 6,303,234 disclose the impregnation of porous combustible materials such as wood to increase fire resistance. However, in both patents, the wooden article was already assembled, and the glue used, if any, was between the wood veneers, chips, flakes, or particles, and was already fully cured, before the wooden article was treated with sodium silicate impregnation. As such, the glue between the wood, if any, was unable to effectively react with the silicate, and the mechanical properties of the adhesive and interface can be vulnerable to damage and/or degradation.

Thus, there remains a need to develop wood articles having improved bonding efficiency to a wood adhesive, improved stability of the wood adhesive, and improved flame resistance for both wood adhesive and wood, while providing enhanced mechanical properties for both wood adhesive and wood. This disclosure addresses that need.

### SUMMARY OF THE INVENTION

The disclosure herein describes a wood article that has improved the efficiency of bonding to a wood adhesive by impregnating the wood with a metal silicate (e.g., sodium silicate), which then exhibits a faster and stronger cure with the wood adhesive, and a process of accomplishing such wood article. This silicate-impregnated wood accomplishes the improvements to the adhesive without lengthy re-formulation of the wood adhesive, and without affecting the pot-life and handling characteristics of the adhesive, as the co-reactants (i.e., wood adhesive and metal silicate) are contained separately within the wood. The adhesive is not modified until the time of contacting with silicate-treated wood during the manufacture. The process can also confine the reaction between the adhesive and metal silicate to the adhesive-wood interface, a reaction that increases the modulus and reduces the cure time, while the portion of the adhesive not in contact with the wood will retain its original properties. The combination of higher modulus at top surfaces and the lower modulus at inner surface of the adhesive can provide ductility and strength not attainable in a homogenous material provided by, e.g., simply using the metal silicate as adhesive or adding the metal silicate to the adhesive to form a re-formulated adhesive. The silicate also improves the physical characteristics of the wood itself, most notably in the flame performance of the wooden article thus formed, and this characteristic further carries into the performance of the adhesive.

The disclosure further provides a process to retrofit a conventional engineered wood manufacturing process line to one that enables the silicate wood impregnation prior to adhesive bonding as part of the manufacturing process.

Thus, one aspect of the invention relates to a process to manufacture a flame-retardant, glued engineered wood article. The process comprises:
providing an engineered wood component treated by impregnation with a metal silicate solution,
exposing the metal-silicate treated engineered wood component to an adhesive, and
bonding multiple units of the metal-silicate treated engineered wood component via the adhesive to form a flame-retardant, glued engineered wood article.

Another aspect of the invention relates to a process to retrofit an engineered wood manufacturing line to manufacture a flame-retardant, glued engineered wood article. The process comprises providing an engineered wood manufacturing line that comprises the operation of the steps of:
forming an engineered wood component,
optionally drying the engineered wood component,
exposing the engineered wood component to an adhesive, and
bonding multiple units of the engineered wood component via the adhesive.
   The process further comprises incorporating into the engineered wood manufacturing line, prior to the step of exposing the engineered wood component to an adhesive, a step of treating the engineered wood component by impregnation with a metal silicate solution.

In some embodiments, the exposing step forms a layer of adhesive on the surface of the metal-silicate treated engineered wood component.

In some embodiments, the reaction between the adhesive and metal silicate provides one or more of the following:
(i) improved bonding efficiency between wood and adhesive by having a faster and stronger cure,
(ii) improved flame resistance of the adhesive by having infusion of the metal silicate embedded in the wood into the adhesive,
(iii) improved stability of the adhesive by minimizing degradation of the adhesive caused by fungi, algae, yeasts, lichen, and/or bacteria,
(iv) improved mechanical property by stiffening the adhesive, and
(v) improved mechanical property by mechanical interlocking of the adhesive and wood via the metal silicate embedded in the wood.

In some embodiments, the bonding of multiple units of the sodium-silicate treated engineered wood component forms a wood-adhesive interface, and wherein the reaction between the adhesive and metal silicate is confined to the wood-adhesive interface, providing an improved ductility and strength due to the combination of a higher modulus at the surface where the adhesive and metal silicate react and a lower modulus at the inner part where the adhesive does not react with the metal silicate.

In some embodiments, the metal silicate is sodium silicate, potassium silicate, lithium silicate, iron silicate, or a mixture thereof. In some embodiments, the metal silicate is sodium silicate, potassium silicate, lithium silicate, or a mixture thereof, forming a solution having about 2-40 wt % solids. In some embodiments, the metal-silicate treated engineered wood component contains about 5-25 wt % silicate solid.

In some embodiments, the impregnation is carried out by applying vacuum and/or pressure. In some embodiments, the vacuum and/or pressure is applied in a batch manner. Alternatively, the vacuum and/or pressure is applied in a continuous manner, e.g., by applying pressure on one side of the wood and applying vacuum on the other side of the wood. In some embodiments, the device for applying vacuum pressure comprises an added recovery line for the metal silicate solution to be supplied at the vacuum side.

In some embodiments, the process further comprises drying the metal-silicate treated engineered wood component to a moisture level of 19% or less, prior to the exposing step.

In some embodiments, the process further comprises at least partially curing the adhesive and/or metal silicate in the treated wood. In some embodiments, the at least partially curing occurs prior to the exposing and/or bonding steps. In some embodiments, the at least partially curing occurs after the exposing and/or bonding steps.

In some embodiments, the metal-silicate treated wood component is uncured, prior to the exposing and/or bonding steps.

In some embodiments, the at least partial curing is carried out by heating.

In some embodiments, the at least partial curing is carried out by a curing agent. In some embodiments, the curing agent is selected from the group consisting of a protic acid, a mineral acid, a lewis acid, a metal salt, CO₂, an organic molecule, an additive, and a multivalent lewis acid salt.

In some embodiments, the process further comprises applying pressure, after the at least partially curing step and/or the bonding step. In some embodiments, the pressure is applied by mechanical clamping or rolling. In some embodiments, the pressure is increased to above atmospheric pressure.

In some embodiments, the impregnation is carried out by applying pressure impregnation alone. In some embodiments, the pressure is applied by mechanical clamping or rolling. In some embodiments, the pressure is increased to above atmospheric pressure.

In some embodiments, the adhesive is an animal glue, phenol/polyphenol/resorcinol-formaldehyde, lignin-phenol-formaldehyde, urea-formaldehyde, melamine-formaldehyde, melamine-urea-formaldehyde, polyurethane, epoxy, polyvinyl alcohol, polyvinyl acetate, cyanoacrylate, casein, aliphatic resin, or contact cement.

In some embodiments, the engineered wood component is plywood, timber, veneer, oriented strand board, chip, flake or strand, particle, or sawdust.

Another aspect of the invention relates to a flame-retardant, glued engineered wood article prepared by the process described in any of the above aspects of the invention and in any of the above embodiments.

Another aspect of the invention relates to use of the flame-retardant, glued engineered wood article described in any of the above aspects of the invention and in any of the above embodiments, for construction, furniture or instrument manufacture, manufacture of structured wood, plywood, oriented strand board, particle board, or wood composite manufacture and development processes.

In some embodiments, provided is the use of the flame-retardant, glued engineered wood article described in any of the above aspects of the invention and in any of the above embodiments for a construction joinery material.

Another aspect of the invention relates to use of the flame-retardant, glued engineered wood article described in any of the above aspects of the invention and in any of the above embodiments for increasing adhesion to polymeric materials.

### BRIEF DESCRIPTION OF THE DRAWINGS

FIG. 1 is a flow chart showing an exemplary process for making a flame-retardant, glued engineered wood article with improved fire resistance and mechanical properties.

FIG. 2 lists exemplary wood morphologies and representative wood structures for use in the process described herein.

FIGS. 3A-3C are schematic showings comparing an exemplary embodiment of the process of the invention (FIG. 3C) against a process of treating a glued wood article with silicate impregnation (FIG. 3A) and a process of manufacturing a glued wood article by using a modified wood adhesive re-formulated by adding additives such as silicate directly to the regular wood adhesive (FIG. 3B).

FIG. 4 is a schematic showing of a typical plywood manufacturing process using wood glue/adhesive.

FIG. 5 is a schematic showing of a plywood manufacturing process incorporating silicate treated veneer.

FIG. 6 is a schematic showing of an inline silicate treatment of veneer in plywood manufacturing process.

FIG. 7 is a schematic showing of a plywood manufacturing process incorporating silicate treatment of veneer into the process, and further incorporating addition of additives, such as curing agents, and drying into the process.

### DETAILED DESCRIPTION OF THE INVENTION

Unless defined otherwise, all technical and scientific terms used herein have the same meaning as is commonly understood by one of skill in the art to which this disclosure belongs. As used in the specification and claims, the singular forms “a,” “an” and “the” include plural references unless the context clearly dictates otherwise.

The embodiments of the invention and the various features and advantages thereto are more fully explained with references to the non-limiting embodiments and examples that are described and set forth in the following descriptions of those examples. Descriptions of well-known components and techniques are omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the claims.

The disclosure herein describes materials and processes to manufacture a wood article that improves the interaction of wood with commonly used wood glues by treating the wood while making no additions to the glue formulation and requiring no re-formulation of the glue. The process not only improves the adhesive bonding and mechanical strength of the wood-adhesive-wood interface, but also provides improved flame retardance and environmental performance.

In this process, wood is treated by a metal silicate solution (e.g., by soaking the wood, coating the wood, or vacuum-pressure impregnation, with an aqueous solution of metal silicate) to interact with adhesive molecules used in engineered wood composites during the manufacture of the engineered wood product to form a silicate functionalized engineered wood. The silicate-treated wood exhibits a faster and stronger cure with the glue, and the silicate treatment also improves the physical characteristics of the wood itself. The disclosure also describes process and design modifications to retrofit or convert conventional engineered wood-manufacturing lines to incorporate in-line methods that infuse the wood with metal silicate, prior to bonding the treated wood with adhesives, during manufacture of the engineered wood articles.

### Process Employing Silicate Functionalization and its Impact on Wood-Adhesive-Wood Interface

One aspect of the invention relates to a process to manufacture a flame-retardant, glued engineered wood article. The process comprises:
providing an engineered wood component treated by impregnation with a metal silicate solution,
exposing the metal-silicate treated engineered wood component to an adhesive, and
bonding multiple units of the metal-silicate treated engineered wood component via the adhesive to form a flame-retardant, glued engineered wood article.

Another aspect of the invention relates to a process to retrofit an engineered wood manufacturing line to manufacture a flame-retardant, glued engineered wood article. The process comprises providing an engineered wood manufacturing line that comprises the operation of the steps of:
forming an engineered wood component,
optionally drying the engineered wood component,
exposing the engineered wood component to an adhesive, and
bonding multiple units of the engineered wood component via the adhesive.
   The process further comprises incorporating into the engineered wood manufacturing line, prior to the step of exposing the engineered wood component to an adhesive, a step of treating the engineered wood component by impregnation with a metal silicate solution.

### Materials and Process Conditions

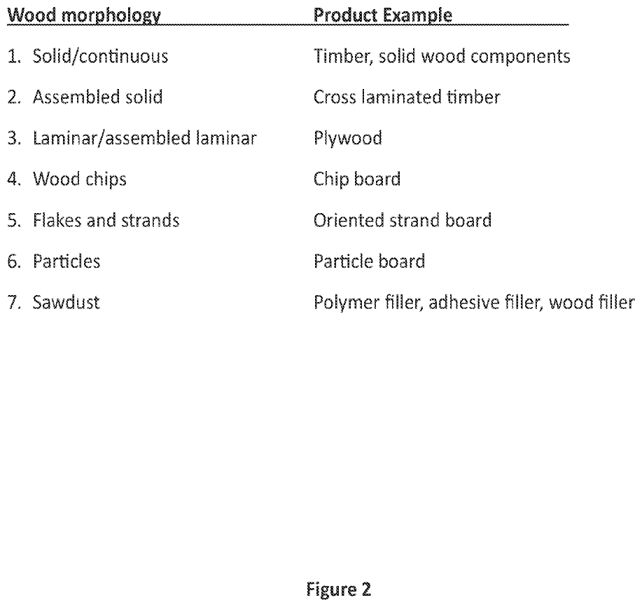

In the process described herein, a wood component (e.g., an engineered wood component) is provided. Any type of wood for gluing are suitable for used in the process described herein. Typical wood used is engineered wood. Wood with any wood morphology may be used, including but are not limited to, veneer, solid/continuous (e.g., timber, lamella, solid wood components), assembled solid (e.g., cross laminated timer), laminar/assembled laminar (e.g., plywood), wood chips (e.g., chip board), flakes and strands (e.g., oriented strand board), particles (e.g., particle board), or sawdust (e.g., polymer filler, adhesive filler, wood filler, etc.). See for instance, FIG. 2. Exemplary types of engineered wood are wood-based panel (e.g., plywood, oriented strand board, fibreboard, particle board), structural composite lumber (e.g., laminated veneer lumber, parallel strand lumber, laminated strand lumber, I-joists), mass timber (cross-laminated timber, glue-laminated timber, dowel laminated timber, nail-laminated timber).

In some embodiments, the wood component used is early wood and/or porous wood. In some embodiments, the wood component used is blue-stain wood. Without being bound by theory, the use of early wood and/or porous wood, and the use of blue-stain wood can increase the silica concentration in the wood article. In some embodiments, the wood component used is hardwood. In some embodiments, the wood component used is softwood. Without being bound by theory, the use of hardwoods or softwoods can affect the extent of silicate impregnation as well as the final properties of the silicate-treated wood. In some embodiments, the engineered wood component is plywood veneer. In some embodiments, the engineered wood component is OSB or particle board.

Prior to exposing the wood component to an adhesive, a metal silicate aqueous solution is used to impregnate the wood component. Suitable metal silicate includes, but are not limited to, sodium silicate, potassium silicate, lithium silicate, iron silicate, or a mixture thereof. In some embodiments, the metal silicate is sodium silicate, potassium silicate, lithium silicate, iron silicate, or a mixture thereof. In some embodiments, the metal silicate is sodium silicate, potassium silicate, lithium silicate, or a mixture thereof. In some embodiments, the metal silicate forms a solution having about 2-40 wt % solids, for instance, a solution having about 2-35 wt %, about 2-30 wt %, about 2-25 wt %, about 2-20 wt %, about 2-15 wt %, about 2-10 wt %, about 2-5 wt %, about 5-40 wt %, about 5-35 wt %, about 5-30 wt %, about 5-25 wt %, about 5-20 wt %, about 5-15 wt %, about 5-10 wt %, about 10-40 wt %, about 10-35 wt %, about 10-30 wt %, about 10-25 wt %, about 10-20 wt %, about 10-15 wt %, about 15-40 wt %, about 15-35 wt %, about 15-30 wt %, about 15-20 wt %, about 20-40 wt %, about 20-35 wt %, about 20-30 wt %, about 25-40 wt %, about 25-35 wt %, or about 30-40 wt % solids (i.e., dissolved metal silicate). In one embodiment, the metal-silicate treated engineered wood component contains about 5-25 wt % silicate solid.

In some embodiments, the metal silicate (e.g., sodium silicate) contains a mixture of different silicates by having different moduli (i.e., the ratio of silica:sodium oxide). In some embodiments, the metal silicate contains a mixture of silicates having different counterions. In some embodiments, the metal silicate contains a mixture of silicates having both different moduli and different counterions.

In some embodiments, the metal silicate solution (e.g., sodium silicate) further include components such as borate, boric acid, surfactant, multivalent salts (e.g., calcium, magnesium, aluminum, and zinc salts).

Impregnation of the metal silicate may be carried out by various manners. The metal silicate solution may be applied to wood by a soaking bath. The impregnation may be carried out by soaking the wood in the metal silicate solution with or without vacuum or pressure. For instance, the wood component may be exposed to a metal silicate (e.g., sodium silicate) solution by soaking in a quiescent or stirred bath without the aid of vacuum or pressure to incorporate the metal silicate into the interstices and/or surface of the wood. Alternatively, the wood component may be exposed to a metal silicate (e.g., sodium silicate) solution by soaking in a quiescent or stirred bath, with the aid of vacuum and/or pressure to incorporate the metal silicate into the interstices and/or surface of the wood.

The metal silicate solution may be applied to wood by surface coating. For instance, the wood component may be exposed to a metal silicate (e.g., sodium silicate) solution by applying the metal silicate (e.g., sodium silicate) solution onto the surface of the wood with or without the use of a subsequent pressure step or repeat/additional application.

In some embodiments, the impregnation is carried out by applying vacuum and/or pressure. In some embodiments, the vacuum and/or pressure is applied in a batch manner. In some embodiments, the vacuum and/or pressure is applied in a continuous manner, e.g., by applying pressure on one side of the wood, and applying vacuum on the other side of the wood. In some embodiments, the device for applying vacuum pressure comprises an added recovery line for the metal silicate solution to be supplied at the vacuum side.

In some embodiments, the impregnation is carried out under a temperature ranging from about 25 to about 100° C., for instance from about 30 to about 80° C., or from about 35 to about 70° C.

In some embodiments, the impregnation is carried out by applying pressure impregnation alone. In some embodiments, the pressure is applied by mechanical clamping or rolling. In some embodiments, the pressure is increased to above atmospheric pressure. Typically, the pressure applied is in a range of from 5 to 200 psi, for instance, from 10 to 200 psi, from 50 to 190 psi, from 100 to 190 psi, from 120 to 190 psi, from 100 to 150 psi, or from 110 to 120 psi.

Impregnation can be carried out for from about 10 minutes to about 24 hours, for instance, from about 10 minutes to about 12 hours, from about 10 minutes to about 6 hours, from about 10 minutes to about 4 hours, from about 10 minutes to about 2 hours, from about 10 minutes to about 60 minutes, from about 30 minutes to about 6 hours, from about 30 minutes to about 4 hours, from about 30 minutes to about 2 hours, or from about 30 minutes to about 60 minutes.

Additional details regarding the types of suitable metal silicates and suitable impregnation conditions can be found in U.S. Pat. Nos. 6,827,984, 6,303,234, and WO 2021/113705, all of which are incorporated herein by reference in its entirety.

The process may comprise an optional drying step where the wood may be analyzed for concentration of silicate by XRF and may be used at this point with the adhesive or chipped, planed, or stranded, as necessary to obtain a different morphology. The drying step can be carried out by ambient air or heating (e.g., oven dry). The silicate-treated wood component may be dried to remove excess moisture, but generally allowed to maintain approximately 19% or less moisture. In some embodiment, the process further comprises a drying step prior to the exposing the engineered wood component to the adhesive.

The process may further comprise at least partially curing or fully curing the metal silicate embedded in wood into a solid by physical or chemical means. Curing of the silicate refers to a process of decreasing the water solubility of metal silicate (e.g., sodium silicate) deposited from the aqueous solution to render the silicate embedded in the wood insoluble. Curing improves the water resistance of the metal silicate (e.g., sodium silicate) infusion as well as the application of silica particles onto the surface of the treated wood to further improve the performance of the wood in the flame environment.

Without being bound by theory, the use of metal silicate (e.g., sodium silicate) also enhances the curing of the adhesive when it is combined with the silicate-impregnated wood.

Curing of metal silicate and/or the adhesive may be accomplished by using an energy source (such as heating), providing an acid source, such as a mineral acid, protic acid, or lewis acid (e.g., HCl, acetic acid, citric acid, phosphoric acid, boric acid, carbonic acid, etc.), metal salt (e.g., calcium chloride, magnesium chloride, aluminum sulfate, etc.), carbon dioxide, an organic molecule, or an additive. Curing may also be accomplished through the addition of multivalent lewis acid salts. Additional curing agents may be found in U.S. Pat. Nos. 9,415,526 and 3,974,318, both of which are incorporated herein by reference in their entirety.

In some embodiments, the metal silicate (e.g., sodium silicate) impregnated wood is at least partially cured or fully cured by heating or by using any of the above described curing techniques.

Curing temperature can range from about 25 to about 100° C., for instance from about 30 to about 80° C., or from about 35 to about 70° C.

Curing or other post treatments can be carried out for from about 10 minutes to about 24 hours, for instance, from about 10 minutes to about 12 hours, from about 10 minutes to about 6 hours, from about 10 minutes to about 4 hours, from about 10 minutes to about 2 hours, from about 10 minutes to about 60 minutes, from about 30 minutes to about 6 hours, from about 30 minutes to about 4 hours, from about 30 minutes to about 2 hours, or from about 30 minutes to about 60 minutes.

The additional curing treatment may occur before or after the exposing and/or bonding steps. In some embodiments, the at least partially curing occurs prior to the exposing and/or bonding steps. In some embodiments, the at least partially curing occurs after the exposing and/or bonding steps. In some embodiments, the metal-silicate treated wood component is cured both before and after the exposing and/or bonding steps.

In some embodiments, the metal-silicate treated wood component is uncured, prior to the exposing and/or bonding steps.

Pressure may be applied after the at least partially curing step, and/or after the bonding step. In some embodiments, the pressure is applied by mechanical clamping or rolling. In some embodiments, the pressure is increased to above atmospheric pressure. Typically, the pressure applied is in a range of from 5 to 200 psi, for instance, from 10 to 200 psi, from 50 to 190 psi, from 100 to 190 psi, from 120 to 190 psi, from 100 to 150 psi, or from 110 to 120 psi.

Bonding of the silicate-treated wood components is then accomplished by the application of a wood glue/adhesive followed by securing the joint until the glue-wood adhesion has been developed and glue has been allowed to fully cure.

The bonding may be carried out by applying pressure until the adhesive has cured into a solid structure.

Suitable adhesives to be used in the process described herein include any wood glues commonly known to one skilled in the art. Exemplary wood glues include, but are not limited to, animal glue (e.g., hoof glue, hide glue, etc.), phenol/polyphenol/resorcinol-formaldehyde, lignin-phenol-formaldehyde, urea-formaldehyde, melamine-formaldehyde, melamine-urea-formaldehyde, polyurethane, epoxy, polyvinyl alcohol, polyvinyl acetate, cyanoacrylate, casein, aliphatic resin, or contact cement. Wood glues may also include inorganic wood glue, such as those based on magnesium oxychloride (e.g., magnesium oxychloride cement-based inorganic adhesive), lead oxide (e.g., litharge), sulfur, and various metallic phosphates (e.g., aluminophosphate inorganic adhesive). In one embodiment, the adhesive is PVA.

Additional details about additional suitable wood adhesives and technology on wood bonding by these wood adhesives may be found in Pizzi et al., “Advanced Wood Adhesives Technology” published by Marcel Dekker, Inc. (NY, 1994); U.S. Pat. No. 10,100,232; and a review article the adhesion of silicate coatings may be found in Yona et al., Coatings, 11: 61-76 (2021), all of which are incorporated herein by reference in their entirety.

Additional additives, such as plasticizing agents, surfactants, accelerant (e.g., sodium bicarbonate), initiator or primer, etc., may be added during the process. These further reactions can further strengthen the wood and provide an improved substrate for the adhesive bond, as well as impart improved flame retardance, insect resistance, and anti-fungal/bacterial characteristics. Each of these additional treatment processes may impart silicate precipitates with differing P hardness, solubility and performance with adhesive and wood articles.

### Additional Embodiments of Exemplary Processes

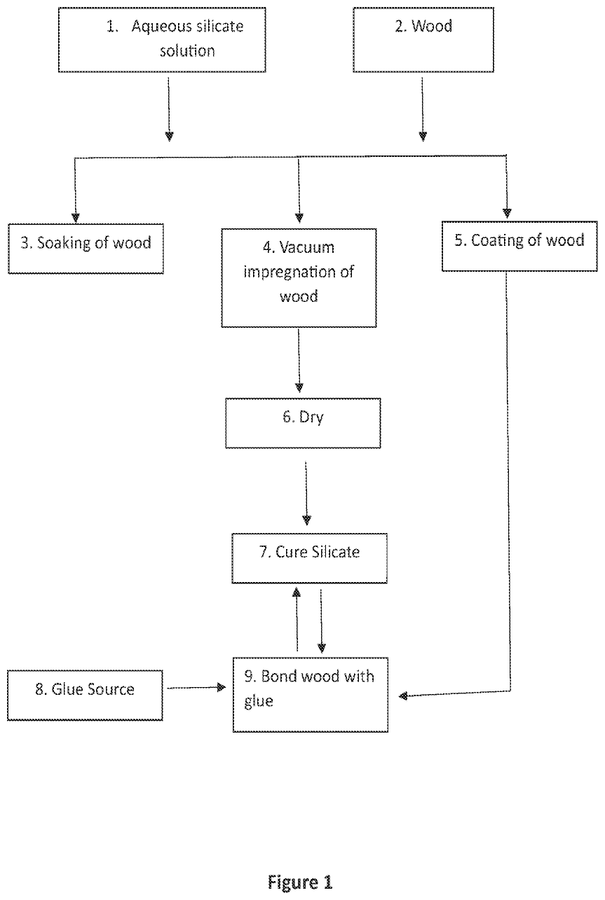

FIG. 1 illustrates an exemplary process for making a flame-retardant, glued engineered wood article with improved fire resistance and mechanical properties. Each step or component illustrated in FIG. 1 is assigned a reference number and corresponding description is provided in the chart below.

| Reference | |
|---|---|
| No. | Description of Step/Component |
| 1 | Aqueous silicate solution |
| 2 | Wood (e.g., sawdust, flakes, chips, lamellae, timber) |
| 3 | Silicate solution application by soaking bath or related |
| 4 | Silicate solution application by vacuum, pressure |
| | impregnation |
| 5 | Silicate solution application by surface coating |
| 6 | Wood drying step by ambient air or heating |
| 7 | Silicate solution embedded in wood cured into a solid by |
| | physical or chemical means |
| 8 | Glue sources such as polyvinyl acetate glue, phenol/ |
| | formaldehyde or urethanes among others. (w/or w/o a silicate- |
| | based filler) |
| 9 | Silicate solution/wood composite exposed to adhesive and |
| | joined to another surface/material |

The chart below provides a more detailed description for each step/component identified in FIG. 1.

| Reference | |
|---|---|
| No. | Description of Step/Component |
| 1 | Aqueous silicate solution. |
| 2 | Wood in the form of, e.g., sawdust, flakes, chips, lamellae, or timber (e.g., |
| | SYP or other wood species). |
| 3 | Expose a wooden structure to a sodium silicate solution by soaking in a |
| | quiescent or stirred bath without the aid of vacuum or pressure to incorporate |
| | the silicate solution into the interstices and/or surface of the wood. E.g., |
| | soaking may be carried out in 10-15 wt % sodium silicate solution at about 45° |
| | C. for about 30-60 minutes. |
| 4 | Expose a wooden structure to a sodium silicate solution by soaking in a |
| | quiescent or stirred bath with the aid of vacuum and/or pressure to incorporate |
| | the silicate solution into the interstices and/or surface of the wood. E.g., an |
| | optional vacuum pre-treatment at ~27 mmHg for 10 minutes; then treatment in |
| | 10-15 wt % sodium silicate solution at about 60° C. and 190 psi for about 30-60 |
| | minutes; and optional vacuum post treatment at ~27 mmHg for 10 minutes. |
| 5 | Expose a wooden structure to a sodium silicate solution by applying the |
| | silicate solution onto the surface of the wood with or without the use of a |
| | subsequent pressure step or repeat/additional application. |
| | Note: steps 3, 4, and 5 may be applied alone, as alternative steps, or together |
| | (sequentially or at one time), and may be carried through steps 6, 7, 8, and/or |
| | 9 sequentially; or skip steps 6-8 and go directly to cure (9) and then to final |
| | product. |
| 6 | The wooden article with embedded or applied sodium silicate is dried to |
| | remove excess moisture, but generally allowed to maintain approximately |
| | 19% moisture, although more or less residual moisture may remain as required |
| | for a specific application. E.g., drying can be air dry under room temperature |
| | or by oven. |
| 7 | The wooden article with embedded or applied sodium silicate is allowed to |
| | react with an energy source (such as heat), an acid (protic or Lewis), CO_{2,} |
| | metal salts, organic molecules, or additives such that the silicate is no longer |
| | soluble in water. |
| 8 | A glue is chosen from common sources such as but not limited to polyvinyl |
| | acetate, phenol/formaldehyde, urethane glue. The adhesives may be used as is |
| | or enhanced by the addition of silicate or other additives. |
| 9 | The wooden article with embedded or applied sodium silicate has glue and, if |
| | required, an accelerant, initiator or primer to its surface followed by mating |
| | with another surface, composite, or structure, followed by the application of |
| | pressure until the adhesive has cured into a solid structure. |

### Mechanisms and Benefits of the Process

Embodiments of this invention describe the use of silicate-modified wood in the manufacture of glued engineered wood, such as plywood, chip board, oriented strand board (OSB), and particle board. The process described herein is different than using metal silicate, such as sodium silicate, as a wood glue or adding metal silicate to wood glue to re-formulate a wood glue (e.g., adding metal silicate as an additive to a wood glue). The process described herein is also different than simply treating a glued wood article with silicate impregnation. The glued engineered wood product prepared by the process described herein has wood being modified by incorporating a metal silicate infusion, and then the treated wood pieces are glued by regular wood adhesives.

The inventors have surprisingly found that glued engineered wood product prepared by the process described herein possesses characteristics similar to or better than that of the glued engineer wood that uses a re-formulated glue having metal silicate addition; and the process described herein also increases both the properties of the engineered wood composite as well as the wood/adhesive interface. Having wood being modified by incorporating a metal silicate infusion also further enhances the fire performance of the adhesive in the glued engineered wood. Without being bound by theory, this result may be explained by the fact that since the burning process occurs from the outer surface, the presence of the silicate embedded in the wood can slow down the burning. In addition, the wood/glue interface also has a silicate infusion into the glue, further improving its flame resistance.

Without being bound by theory, in the process described herein, upon exposure to the adhesive, the metal silicate (e.g., sodium silicate) within the wood may react with the adhesive and stiffen the adhesive, and thus the adhesive is stiffened more quickly than the scenario where the wood is not silicate treated. This reaction can not only improve the mechanical properties, e.g., by causing a higher modulus bond at the wood-adhesive interface, but can further enhance the water and moisture resistance, as well as the flame resistance by reducing flow and drip performance of the adhesive, particularly in the wood-adhesive bonding region. Additionally, as the metal silicate (e.g., sodium silicate) is embedded in the wood structure, the mechanical interlock of the adhesive to the wood can be improved by having a harder adhesive/silicate composite embedded within the pores of the wood. This latter result cannot be achieve when simply adding silicate to the wood adhesive.

In some embodiments, the reaction between the adhesive and metal silicate provides improved bonding efficiency between wood and adhesive by having a faster and stronger cure. In some embodiments, the reaction between the adhesive and metal silicate provides improved flame resistance of the adhesive by having infusion of the metal silicate embedded in the wood into the adhesive. In some embodiments, the reaction between the adhesive and metal silicate provides improved stability of the adhesive by minimizing degradation of the adhesive caused by fungi, algae, yeasts, lichen, and/or bacteria. In some embodiments, the reaction between the adhesive and metal silicate provides improved mechanical property by stiffening the adhesive. In some embodiments, the reaction between the adhesive and metal silicate provides improved mechanical property by mechanical interlocking of the adhesive and wood via the metal silicate embedded in the wood.

In some embodiments, the applied adhesive on the silicate-treated wood reacts solely at the surface, which introduces various benefits to the wood article thus formed. First, the adhesive can adhere and cure quickly at the surface of the wood, thereby increasing its modulus, while the remaining bulk of the adhesive stays unaffected, thus curing at a slower rate and retaining a somewhat lower modulus. This will allow the inner parts of the adhesive to retain working characteristics longer and impart a hard surface over the top of a soft inner surface, a characteristic that can improve impact characteristics. This characteristic depends on the thickness of the adhesive layer and the ratio of the hard/soft thickness.

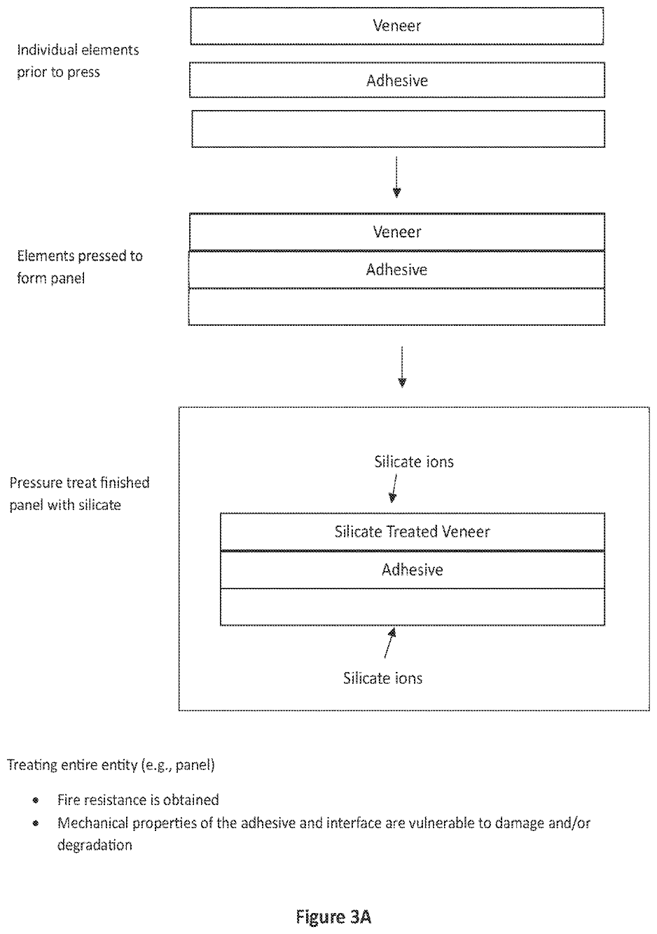

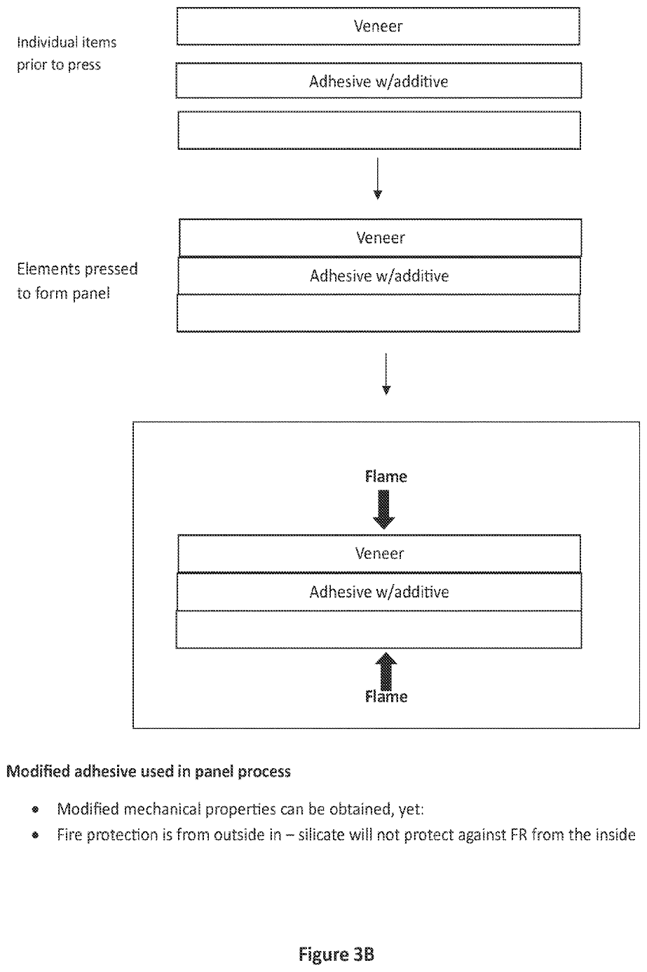

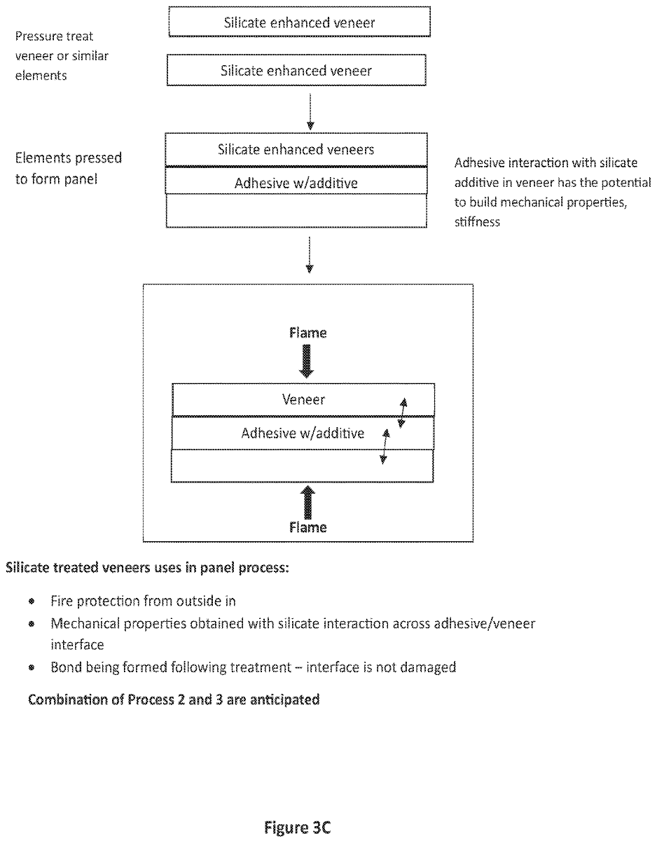

The unique benefit brought by the process described herein, as compared to the other processes is illustrated in FIGS. 3A-3C.

FIG. 3A illustrates a process of treating a glued wood article with silicate impregnation. In FIG. 3A, individual wood elements are pressed together with a wood adhesive to form a panel. Then the finished panel is pressure treated with a silicate solution to achieve fire resistance. In this scenario, fire resistance may be obtained by this process. However, mechanical properties of the adhesive and wood-adhesive-wood interface may be vulnerable to damage and/or degradation.

FIG. 3B illustrates a process of manufacturing a glued wood article by using a modified wood adhesive re-formulated by adding additives such as silicate directly to the regular wood adhesive. In FIG. 3B, individual wood elements are pressed together with the modified wood adhesive to form a panel. In this scenario, modified mechanical properties may be obtained. However, because the burning process occurs from the outer surface of the panel and the fire protection needed would be from outside in, whereas the silicate contained in the adhesive, between wood and is inside the panel, cannot provide the protection against flame that starts from outside the panel, thus sacrificing the fire resistance.

FIG. 3C illustrates an exemplary embodiment of the process described herein for manufacturing a glued, engineered wood article. In FIG. 3C, individual wood elements are treated with a metal silicate (e.g., sodium silicate) solution impregnation, and the silicate-treated wood elements are pressed together with a wood adhesive to form a panel. In this scenario, the silicate embedded in wood can interact across adhesive-wood interface: the adhesive interacts with silicate, which contributes to building mechanical properties, such as stiffen the adhesive; and bond at the adhesive-wood interface can be formed by improving the mechanical interlock of the adhesive to the wood by having a harder adhesive/silicate composite embedded within the pores of the wood, and thus the wood-adhesive-wood interface is not damaged. Additionally, the embedded silicate in the wood can provide fire protection from outside in, slowing down the burning; and the wood-adhesive interface can also have a silicate infusion into the adhesive, further improving its flame resistance.

Besides these benefits discussed above, the process described herein eliminates the need for re-formulation of the wood adhesive by using commercial adhesive, thereby preventing the short pot-life of the re-formulated adhesive caused by direct addition of the metal silicate (e.g., sodium silicate) to the adhesive. This latter benefit is very important for construction sites and other high-throughput manufacturing sites, because the process described herein ensures the pot-life of the adhesive thereby maintaining the adhesive as fluid until being contacted with the wood and reducing the time necessary for the bond to be immobile. As such, the process described herein aids both adhesive consumption and time necessary to secure the joint(s).

### Retrofitting

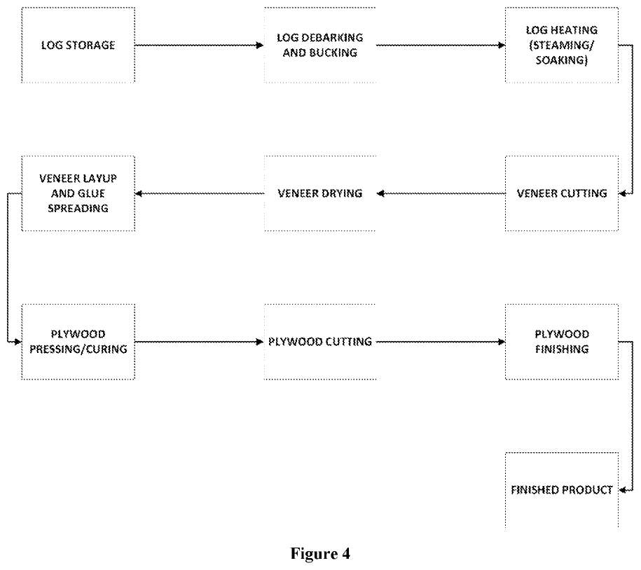

A typical process to manufacture plywood is presented as an archetype for the manufacture of glued wood products, as displayed in FIG. 4. See the diagram in Air Emissions Factors/AP-42 by United States Environmental Protection Agency, 5th Edition, Vol. 1, Chapter 10: Wood Products Industry, 10.5 Plywood Manufacturing (1995), which is incorporated herein by reference in its entirety. The process may be simplified to the steps of forming a veneer, drying, gluing, and pressing.

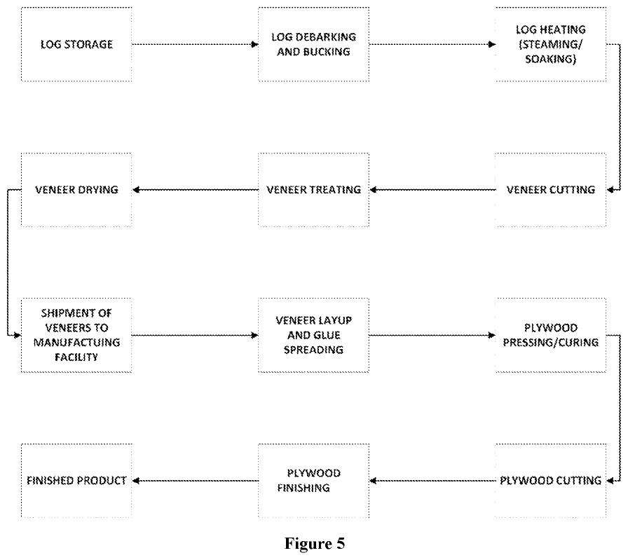

This typical process may be modified to manufacture a glued, silicate-treated veneer, either by treating veneer in a separate silicate treatment step, or by forming a veneer from a silicate-treated log, which could then be used directly into the process. This is illustrated in FIG. 5.

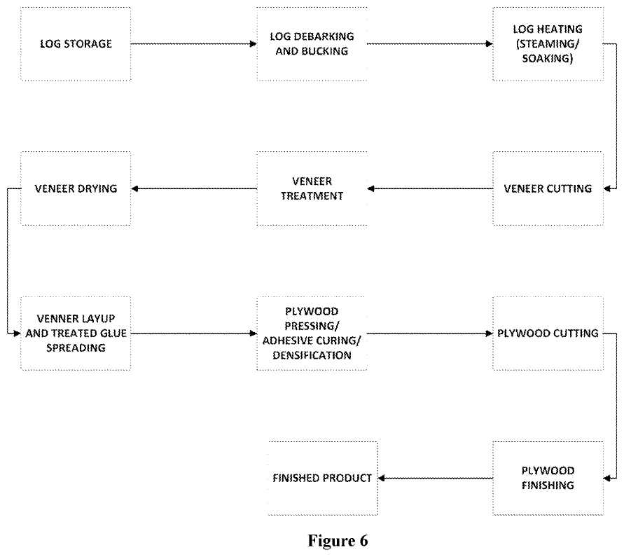

Alternatively, an inline silicate treatment can be used to treat (e.g., pressure treat) the veneer after its formation. This inline silicate treatment can be accomplished through a standard vacuum pressure impregnation step, drying of veneer followed by pressure vacuum impregnation, or applying pressure (e.g., by mechanical pressure or increased to above atmospheric pressure) alone on the veneer to embed the silicate into the wood veneer. The treated veneer can then be dried, exposed to the glue, and pressed into a finished product as shown in FIG. 6.

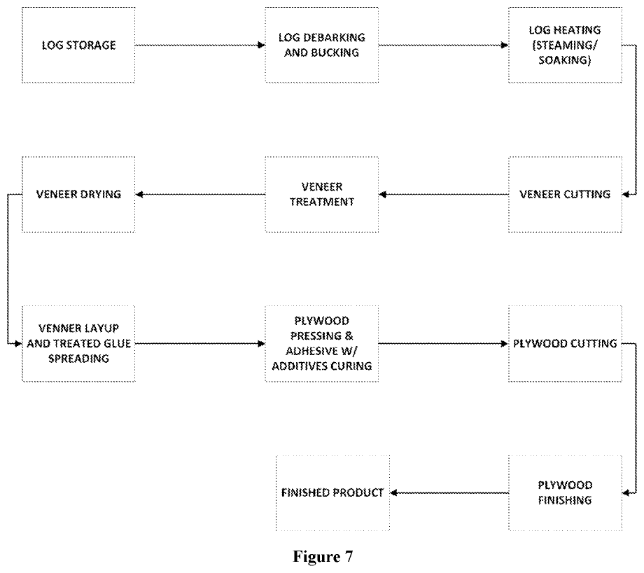

Additionally, further chemical treatments may be added to the manufacture process to e.g., cure the silicate by adding curative agents such as protic acids or lewis acid metal salts, adding additives to adjust final pH, or adding other additives such as anti-fungal, insecticidal, or pigments. This is illustrated in FIG. 7.

Additional details about conventional engineered wood-manufacturing lines, and manners to retrofit or convert conventional engineered wood-manufacturing lines can be found in PCT/US2023/025457, filed on Jun. 15, 2023, which is incorporated herein by reference in its entirety.

Another aspect of the invention relates to a flame-retardant, glued engineered wood article prepared by the processes described in the above aspects of the invention.

All above descriptions and all embodiments discussed in the above aspect relating to the process to manufacture a flame-retardant, glued engineered wood article, and in the above aspect relating to the process to retrofit an engineered wood manufacturing line to manufacture a flame-retardant, glued engineered wood article are applicable to this aspect of the invention relating to the flame-retardant, glued engineered wood article.

This improved wood can be used in any applications where the use of glued wood is currently employed. For instance, a suitable application of the flame-retardant, glued engineered wood article include but are not limited to, construction, furniture or instrument manufacture, manufacture of structured wood (such as cross laminated timber or other engineered wood), plywood, oriented strand board, particle board, or wood composite manufacture and development processes.

In some embodiments, the flame-retardant, glued engineered wood article prepared by the processes described herein may be used as a construction joinery material.

In some embodiments, the flame-retardant, glued engineered wood article prepared by the processes described herein may be used to increase adhesion to polymeric materials.

### Examples

The following examples are for illustrative purposes only and are not intended to limit, in any way, the scope of the present invention.

### Example 1. Laboratory Treatment of Chips/Strands to Determine the Silicate Impregnation

Using a power planer (DeWalt Thickness Planer), longer strands or chips were created. OSB strands were obtained. These strands were soaked in a 10 wt % solution of sodium silicate.

### Exemplary Treating Formulation:

7.1% sodium silicate
2.5% sodium hydroxide
0.4% protic acid (boric acid)
90% water.

The strands were soaked for 30 minutes, and 60 minutes, respectively, in a beaker held at 45° C. Then the strands were rinsed with water, and dried in an oven.

The treated strands were then tested using X-ray fluorescence spectrometry (XRF) to determine the percentage of silicate in the silicate-treated strands. The results are shown in the following chart.

| | | 30 minutes | 60 minutes |
|---|---|---|---|
| Silicate amts. | 1 | 5.92% | 5.42% |
| | 2 | 5.80% | 5.43% |
| | Average | 5.86% | 5.43% |

As shown in the chart, under both treatment conditions (30 minutes and 60 minutes), approximately 5.4-6.0% silicate was present in the strands treated by silicate impregnation.

### Example 2. Pressure Treatment and Flame Testing of Strands/Chips with Silicate Impregnation

Wood chips were placed in a wire basket that contained them during the treatment process. The woodchips were then treated with the following process:
Pre-treatment: vacuum from −20 to 30 mm Hg for 5-30 minutes.
Treating formulation and conditions:
   Treatment formulation:
      41.5% sodium silicate
      0.4% protic acid (boric acid)
      0.4% protic acid (acetic acid)
      57.7% water
   Conditions of treatment of the woodchips in a reactor:
      Temperature of the treating solution ranged from 35 to 70° C.
      Pressure ranged 120 to 190 psi
      Treatment time=30 to 120 minutes

After the above silicate impregnation treatment and after the treating formulation was removed from the reactor,
Vacuum for 5 to 30 minutes at −20-30 mm Hg
CO₂ treatment 30-120 minutes

The wood chips were then allowed to air dry for 3 days, followed by oven drying at 80° C.

The silicate content was then measured using XRF. The silicate content of the woodchips treated were also compared to that of the untreated chips. The tested woodchips included: untreated chips/stranded (Sample No. 1), chips/strands treated with all the above steps (Sample No. 2), and chips/strands treated by above pre-treatment and treating steps, and then rinsing with room-temperature water and dried in an oven (Sample No. 3). The results of the silicate content of various woodchip samples are shown in the chart below.

The sample woodchips (Sample Nos. 1-3) were then exposed to burn test to determine their ability to resist flame spread. The test was performed with a hand propane torch, with the samples placed in metal pans. The flame was positioned seven inches from the sample, and the burning was conducted for 30 and 60 seconds, respectively. The samples were weighed before and after burning, with the weight loss being recorded. The results of burn test of various woodchip samples are shown in the chart below.

Weight Loss when burned**

| | | [symbol] | 60 seconds | 30 seconds | [symbol] |
|---|---|---|---|---|---|
| 1 | [symbol] | [symbol] | [symbol] | [symbol] | [symbol] |
| 2 | [symbol] | [symbol] | [symbol] | [symbol] | [symbol] |
| 3 | [symbol] | [symbol] | [symbol] | [symbol] | [symbol] |
| | | [symbol] | [symbol] | [symbol] | [symbol] |

[symbol]

indicates data missing or illegible when filed

As shown in the chart above, the treated woodchips for both treated samples had a weight loss about 11 and 12% less as compared to the weight loss of the untreated woodchips, after 60-second burning and 30-second burning, respectively. Additionally, upon removal of the flame, the treated woodchips quickly extinguished, while the untreated chips continued to burn for 60 seconds.

### Example 3: Laboratory Flame Testing of Adhesives Combined with Sawdust and Silicate Treated Sawdust

Sawdust from wood was treated by a process as described in Example 2, with the exception that a higher level of silicate (i.e., 23% [Si]) was obtained. The control sawdust was untreated sawdust.

Equal volumes of each sawdust sample (silicate-treated sawdust v.s. untreated sawdust control) were added to a 2-inch radius pool of liquid adhesive, and the sawdust was mixed in by stirring.

The silicate-treated sawdust formed a cohesive solid within three minutes and was dry to the touch shortly thereafter. The control sawdust required 48 hours to dry thoroughly.

The sawdust samples were then exposed to burn test to determine their ability to resist flame spread. The test was performed with a hand propane torch, with the samples held in a vice grip and exposed to 10 seconds of flame. The flame was positioned seven inches from the sample. The burning was conducted for 30 and 60 seconds for the control sample, while the burning extinguished within 2-3 seconds for the treated sample. The treated sample was also noticed to contain heat longer but did not re-ignite or drip.

1. A process to manufacture a flame-retardant, glued engineered wood article, comprising:
providing an engineered wood component treated by impregnation with a metal silicate solution,
exposing the metal-silicate treated engineered wood component to an adhesive, and bonding multiple units of the metal-silicate treated engineered wood component via the adhesive to form a flame-retardant, glued engineered wood article.

2. (canceled)

3. The process of claim 1, wherein the exposing step forms a layer of adhesive on the surface of the metal-silicate treated engineered wood component.

4. The process of claim 1, wherein the reaction between the adhesive and metal silicate provides one or more of the following:
(i) improved bonding efficiency between wood and adhesive by having a faster and stronger cure,
(ii) improved flame resistance of the adhesive by having infusion of the metal silicate embedded in the wood into the adhesive,
(iii) improved stability of the adhesive by minimizing degradation of the adhesive caused by fungi, algae, yeasts, lichen, and/or bacteria,
(iv) improved mechanical property by stiffening the adhesive, and
(v) improved mechanical property by mechanical interlocking of the adhesive and wood via the metal silicate embedded in the wood.

5. The process of claim 1, wherein the bonding of multiple units of the sodium-silicate treated engineered wood component forms a wood-adhesive interface, and wherein the reaction between the adhesive and metal silicate is confined to the wood-adhesive interface, providing an improved ductility and strength due to the combination of a higher modulus at the surface where the adhesive and metal silicate react and a lower modulus at the inner part where the adhesive does not react with the metal silicate.

6. The process of claim 1, wherein the metal silicate is sodium silicate, potassium silicate, lithium silicate, iron silicate, or a mixture thereof.

7. The process of claim 6, wherein the metal silicate is sodium silicate, potassium silicate, lithium silicate, or a mixture thereof, forming a solution having about 2-40 wt % solids.

8. The process of claim 7, wherein the metal-silicate treated engineered wood component contains about 5-25 wt % silicate solid.

9. The process of claim 1, wherein the impregnation is carried out by applying vacuum and/or pressure.

10. The process of claim 9, wherein the vacuum and/or pressure is applied in a batch manner.

11. The process of claim 9, wherein the vacuum and/or pressure is applied in a continuous manner, by applying pressure on one side of the wood and applying vacuum on the other side of the wood.

12. The process of claim 11, wherein the device for applying vacuum pressure comprises an added recovery line for the metal silicate solution to be supplied at the vacuum side.

13. The process of claim 1, further comprising drying the metal-silicate treated engineered wood component to a moisture level of 19% or less, prior to the exposing step.

14. The process of claim 1, further comprising at least partially curing the adhesive and/or metal silicate in the treated wood.

15. The process of claim 14, wherein the at least partially curing occurs prior to the exposing and/or bonding steps.

16. The process of claim 14, wherein the at least partially curing occurs after the exposing and/or bonding steps.

17. The process of claim 1, wherein the metal-silicate treated wood component is uncured, prior to the exposing and/or bonding steps.

18. The process of claim 16, wherein the at least partially curing is carried out by heating.

19. The process of claim 16, wherein the at least partially curing is carried out by a curing agent.

20. The process of claim 19, wherein the curing agent is selected from the group consisting of a protic acid, a mineral acid, a lewis acid, a metal salt, CO2, an organic molecule, an additive, and a multivalent counterion.

21. The process of claim 1, further comprising applying pressure, after the at least partially curing step and/or the bonding step.

22. The process of claim 1, wherein the impregnation is carried out by applying pressure impregnation alone.

23. The process of claim 21, wherein the pressure is applied by mechanical clamping or rolling.

24. (canceled)

25. The process of claim 1, wherein the adhesive is an animal glue, phenol/polyphenol/resorcinol-formaldehyde, lignin-phenol-formaldehyde, urea-formaldehyde, melamine-formaldehyde, melamine-urea-formaldehyde, polyurethane, epoxy, polyvinyl alcohol, polyvinyl acetate, cyanoacrylate, casein, aliphatic resin, or contact cement.

26. The process of claim 1, wherein the engineered wood component is plywood, timber, veneer, oriented strand board, chip, flake or strand, particle, or sawdust.

27. (canceled)

28. (canceled)

29. (canceled)

30. (canceled)

31. A process to retrofit an engineered wood manufacturing line to manufacture a flame-retardant, glued engineered wood article, comprising:
providing an engineered wood manufacturing line that comprises the operation of the steps of:
forming an engineered wood component,
optionally drying the engineered wood component,
exposing the engineered wood component to an adhesive, and bonding multiple units of the engineered wood component via the adhesive; and
incorporating into the engineered wood manufacturing line, prior to the step of exposing the engineered wood component to an adhesive, a step of treating the engineered wood component by impregnation with a metal silicate solution.
